(19) United States
(12) Patent Application Publication
(10) Pub. No.: US 2006/0149765 A1
(43) Pub. Date: Jul. 6, 2006

(54) Methods, systems, and computer program products for managing system resources

(76) Inventors: Joseph Knoerle, Atlanta, GA (US); Fariborz Behi, Alpharetta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/026,585

(22) Filed: Dec. 30, 2004

(51) Int. Cl. G06F 17/30

(52) U.S. Cl. 707/101

(57) ABSTRACT

Exemplary embodiments relate to methods, systems, and computer program products for managing system resources. The method includes assigning a first value to the lowest index of a range, the lowest index specifying a first available resource in the range. The first value is operable for indicating that all resources appearing further in the range are available. The method further includes assigning a second value to the highest index of the range. The highest index specifies a last available resource in the range. The method also includes storing only the lowest index of the range and the highest index in the range, along with corresponding first value and second value, in a storage device.

### BACKGROUND OF THE INVENTION

Exemplary embodiments of the invention relate generally to managing system resources, and more particularly, to methods, systems, and computer program products for managing allocation and de-allocation of system resources to resource-consumption elements.

Various systems track resources that are allocated for usage. When an unused resource is needed, a system keeping track of the resources needs to be able to find an unused resource. For example, in the Asynchronous Transfer Mode (ATM) protocol, a Digital Subscriber Line (DSL) Network Management System (NMS) keeps track of the Virtual Channel Identifiers (VCIs) allocated on a particular physical port. When a new VCI is needed, the NMS provides a resource that has not yet been allocated.

One common way for tracking resources is to use a pool where resources are either put into a list and marked as being allocated, or removed from the pool and marked as being de-allocated. This can be problematic; particularly for larger systems that handle a large volume of resources, because these systems need to maintain lists of these resources in storage. In the DSL NMS example with VCIs, the NMS maintains a list of every VCI value from 32 through 1023. As a VCI is requested, it is removed from the list; however, the list remains quite large.

What is needed, therefore, is a way to manage resource allocations for large amounts of resources without requiring large amounts of computer memory and disk space. What is also needed is a way to efficiently manage these resources at greater speed.

### SUMMARY OF THE INVENTION

Exemplary embodiments relate to methods, systems, and computer program products for managing system resources. Methods include assigning a first value to the lowest index of a range, the lowest index specifying a first available resource in the range. The first value is operable for indicating that all resources appearing further in the range are available. The methods further include assigning a second value to the highest index of the range. The highest index specifies a last available resource in the range. The methods also include storing only the lowest index of the range and the highest index in the range, along with corresponding first value and second value, in a storage device.

Exemplary embodiments further include systems for managing system resources. Systems include a resource management application executing on a processor. The processor is in communication with consumable resources. The resource management application assigns a first value to the lowest index in a range, which specifies a first available resource in the range. The first value indicates that all resources appearing further in the range are available. The resource management application also assigns a second value to the highest index of the range, which specifies a last available resource in the range. The lowest index of the range and the highest index in the range are stored in memory, along with their corresponding first value and second value.

Computer program products for managing system resources include instructions for performing a method. The method includes assigning a first value to the lowest index of a range, the lowest index specifying a first available resource in the range. The first value is operable for indicating that all resources appearing further in the range are available. The method further includes assigning a second value to the highest index of the range. The highest index specifies a last available resource in the range. The method also includes storing only the lowest index of the range and the highest index in the range, along with corresponding first value and second value, in a storage device.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the resource management activities may be implemented in exemplary embodiments;

FIG. 2 is a block diagram of a telecommunications system upon which the resource management activities may be implemented in exemplary embodiments;

FIG. 3 is a flow diagram of a process for implementing the resource management activities in exemplary embodiments; and

FIG. 4 is a flow diagram of a process for initializing an array index for use in implementing the resource management activities in exemplary embodiments.

### DETAILED DESCRIPTION OF EXEMPLARY EMBODIMENTS

According to exemplary embodiments, the resource management activities provide resource allocation and de-allocation services to resource consumption elements. These services may be implemented for large numbers of resources without requiring appreciable amounts of computer memory and disk space. The resource management activities maintain one or more arrays with an index value pointing to the lowest number range of the available resources and an index value pointing to the highest number range of the available resources. A third index value may be utilized to point to a de-allocated resource that is currently-available for re-allocation. This system enables an entity to store only the array indexes for which an index value has been assigned, thus, reducing the amount of storage space typically required for large numbers of resources.

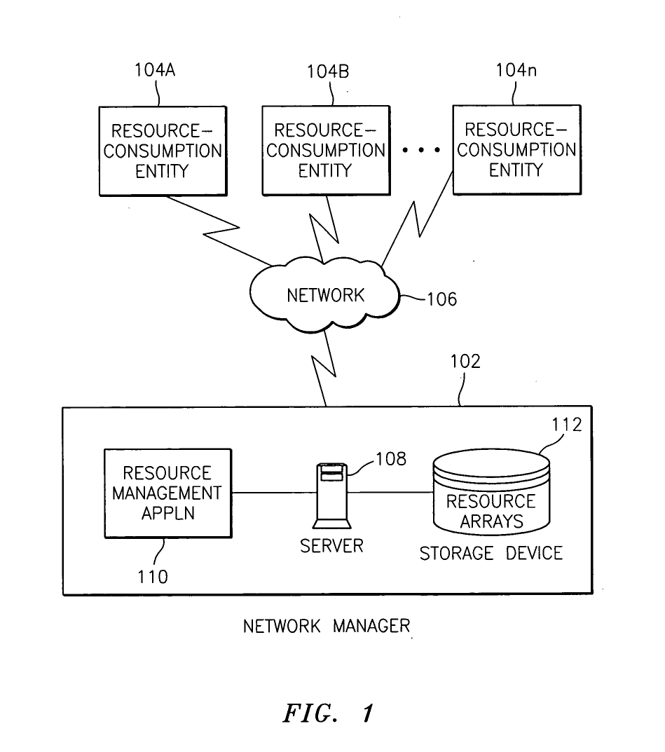

Referring now to FIG. 1, a block diagram of an exemplary system for implementing the resource management activities is generally shown. The exemplary system of FIG. 1 includes a network manager 102 in communication with one or more resource-consumption elements 104A-104n over a network 106. Network manager 102 refers to the entity implementing the resource management activities described herein.

According to exemplary embodiments, the network 106 may be implemented via any type of network that supports application layer communications (e.g., Internet, intranet, TCP/IP over dial-up (PSTN), etc.). Resource-consumption elements 104A-104n may communicate with network manager 102 via the network 106 utilizing one or a combination of communications technologies including, e.g., satellite or cellular technology, circuit-switched networking, and packet-switched networking, among others.

In accordance with exemplary embodiments, resource consumption elements 104A-104n may comprise, for example, an application, a network node, a personal computer, a server, or any type of suitable element that requests and consumes system resources.

Network manager 102 provides resource management services to authorized resource-consumption elements (e.g., 104A-104n). In exemplary embodiments, network manager 102 includes a server 108 that executes a resource management application 110. Server 108 may comprise any suitable high-speed microprocessor capable of handling the volume of activities provided by the features and functions of the resource management application 110. Server 108 may be accessed over the communications network 106 and may further include a security feature or firewall (not shown) in order to protect the integrity of the data stored within network manager 102.

According to an exemplary embodiment, the resource management application 110 includes business rules for handling the allocation and de-allocation of resources with respect to the resource-consumption elements 104A-104n. The resource management application 110 includes logic that performs functions such as initializing arrays of resources, identifying resource activities as requests for allocation or de-allocation, and tracking and updating the array indexes in response to allocations and de-allocations of resources.

In exemplary embodiments, network manager 102 includes a storage device 112 that is in communication with the server 108 over a network such as a local area network, wide area network, virtual private network, etc. In accordance with exemplary embodiments, storage device 112 refers to an on-site network storage system that stores indexes of arrays relating to system resources; however, the storage device 112 need not be physically associated with server 108.

Resources may be Internet addresses IP addresses, telephone numbers, or any other element that can be defined by a range with a beginning and ending. Resource arrays specify a beginning and end range for resources managed by the network manager 102 and include an index value of ‘1’, ‘2’, and/or ‘0’ as will be described further herein.

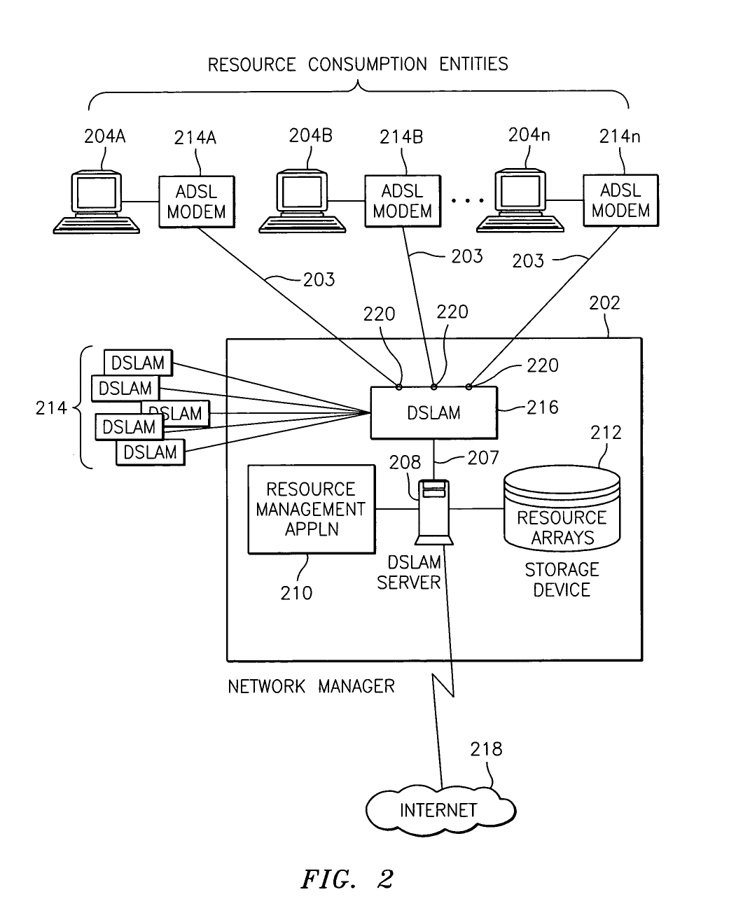

Turning now to FIG. 2, an exemplary implementation of the resource management activities with respect to a telecommunications system will now be described. The system of FIG. 2 includes a network manager 202 in communication with resource-consumption entities 204A-204n over local loops 203 (e.g., copper lines). Network manager 202 provides digital subscriber line (DSL) services to customers via resource consumption elements 104A-104n. Network manager 202 may include a local exchange or central office of a telecommunications service provider. The network manager 202 may also include an Internet Service Provider (ISP) that provides access to the Internet 218 via broadband access and network servers (not shown).

According to an exemplary embodiment, network manager 202 includes a digital subscriber line access multiplexor (DSLAM) 216 which receives resource requests from one or more of resource consumption elements 204A-204n via asymmetric digital subscriber line (ADSL) modems 114A-114n, respectively. Digital subscriber line communications are well known and will be appreciated by those skilled in the art. Communications between ADSL modems 114A-1 14n and DSLAM 216 may utilize standard transmission protocols such as Asynchronous Transfer Mode (ATM). DSLAM 216 handles the resource management activities for a limited region via local loops 203 and may also handle resource management activities received from other DSLAMs 214 which service other geographic regions. DSLAM 216 may include a bank of ADSL modems on one side and a fibre optic data connection 207 on the other side. The DSLAM 216 consolidates the ADSL user connections from resource consumption entities 204A-204n (as well as DSLAMs 214) onto the fibre optic connection 207 for transmission to a DSLAM server 208.

In exemplary embodiments, the resources requested and managed by network manager 202 include elements that enable connectivity to the network manager 202 via a virtual channel identifier/virtual path identifier addressing scheme. VCI/VPI addressing includes parameters configured on ADSL modems 214A-214n to connect to DSLAM 216. Resource allocation may include assignment of a resource-consumption element (e.g., 204A) to a specific physical port within network manager 202. As shown in the system of FIG. 2, the physical ports reside on DSLAM 216.

Resource consumption entities 204A-204n may comprise personal computers (e.g., a desktop, laptop, or other similar general-purpose computing device known in the art). As shown in the system diagram of FIG. 2, resource consumption entities 204A-204n are coupled to an ADSL modem 214A-214n. When requesting a resource, resource consumption entities 204A-204n utilize ADSL modems 214A-214n to initiate connectivity.

According to an exemplary embodiment, DSLAM server 208 executes a resource management application 210 for conducting the resource management activities described herein. DSLAM server 208 may comprise any suitable high-speed microprocessor capable of handling the volume of activities provided by the features and functions of the resource management application 210. DSLAM server 208 is in communication with a storage device 212 that stores resource arrays that specify the resources available by network manager 202. DSLAM server 208 may also convert ATM-based signals from DSLAM 216 to TCP/IP-formatted communications suitable for transmission over the Internet 218.

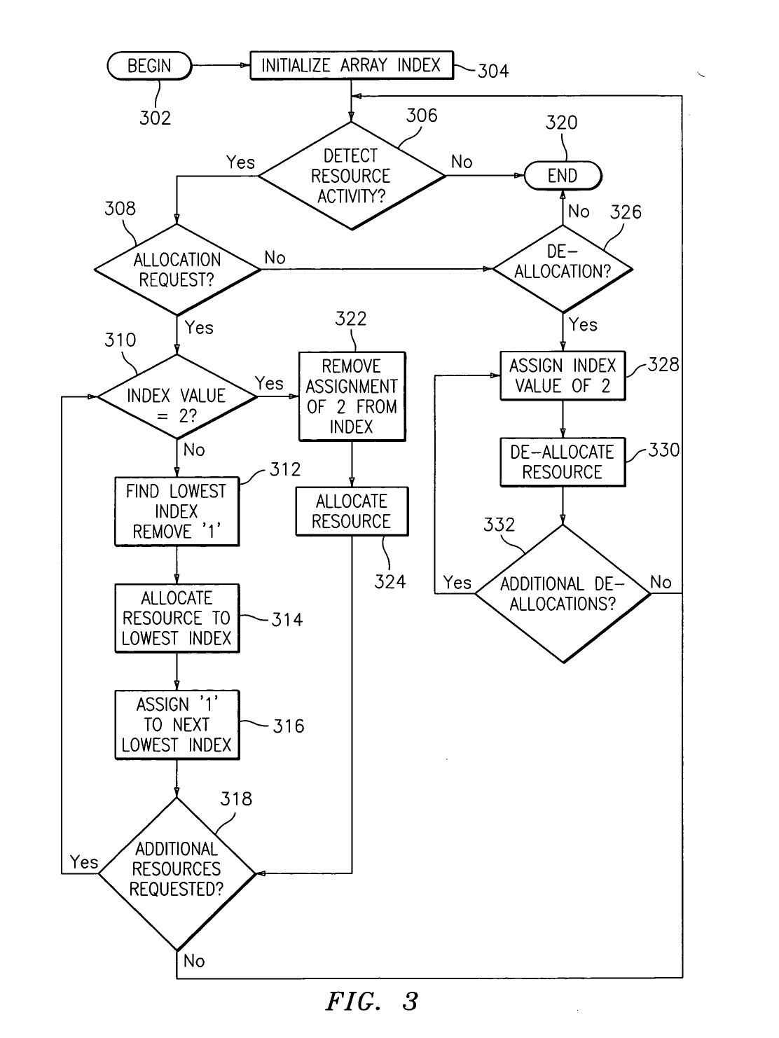

An exemplary process for managing system resources will now be described with respect to the flow diagram of FIG. 3. The process described in the flow diagram of FIG. 3 assumes that the implementation of the resource management activities relate to a telecommunications system such as the system described in FIG. 2.

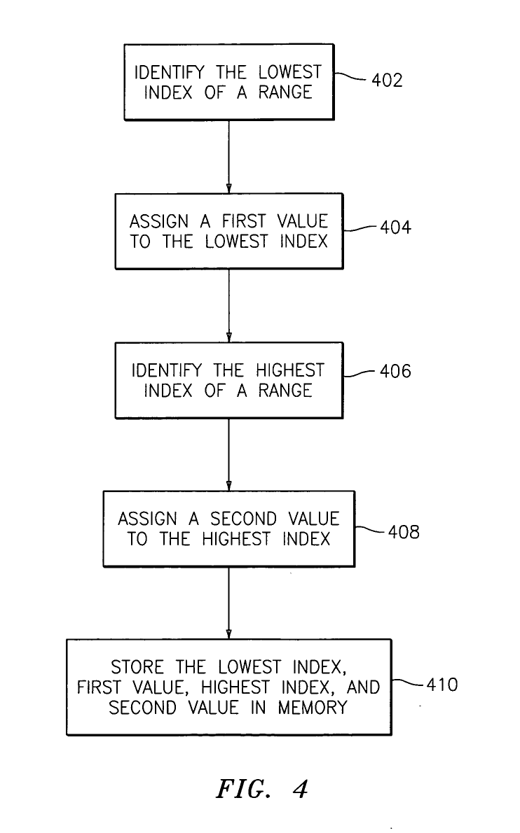

The process begins at step 302 whereby the resource management application 210 is initialized by, e.g., a system administrator of the network manager 202 at step 304. The initialization process is described in the flow diagram of FIG. 4. At step 402, the lowest index of a range for the array is identified (e.g., utilizing the DSL NMS example, the lowest index is 32. A first value is assigned to the lowest index at step 404. The first value indicates that the corresponding index is available for allocation and that all resources in the array that appear subsequent to the lowest index are available for allocation.

At step 406, the highest index in the range for the array is identified (e.g., utilizing the DSL NMS example, the lowest index is 1023). A second value is assigned to the highest index at step 408. The second value indicates the last resource in the array that is available for allocation. The lowest index and its corresponding first value and the highest index and its corresponding value are stored in memory (e.g., storage device 212 of FIG. 2).

Once the array has been initialized, the process returns to the flow diagram of FIG. 3, whereby the resource management application 210 monitors network activities conducted via local loops 203. At step 306, it is determined whether a resource activity has been detected (e.g., request for resource allocation or a resource de-allocation). If so, the resource management application 210 next determines the nature of the activity at step 308 (e.g., whether the activity relates to a request for a resource, or allocation). If so, the resource management application 210 examines the array index and determines at step 310 whether there are any index assignments indicating that the corresponding VCI has been de-allocated and is available for allocation. For illustrative purposes, the value ‘1’ may be used to indicate that all resources listed after the index are available for allocation. Thus, as shown in FIG. 3, an index assignment of ‘2’ may be used to indicate that the VCI has been de-allocated and is available for allocation. Since the array index has just recently been initialized, it is unlikely that the index will have any assigned values of ‘2’. If the index does not have any assigned value of ‘2’, the resource management application 210 finds the lowest index in the array at step 312 and removes the ‘1’ assigned to it (the value ‘1’ indicating that all resources listed after the index are available for allocation). At step 314, the resource management application 210 allocates the corresponding resource (e.g., VCI) to the lowest index found. The resource management application 210 then assigns a ‘1’ to the next lowest index in the array at step 316.

The resource management application 210 determines whether any additional resources are requested at step 318. If not, the process ends at step 320. Otherwise, the process returns to step 310. Returning to step 310, if the index value equals ‘2’, the resource management application 210 removes the assignment of the ‘2’ to the index at step 322 and allocates the resource to the requesting entity at step 324 and the process proceeds to step 318. If no additional resources are requested at step 318, the process returns to step 306 whereby the resource management application 210 continues to monitor activities.

Turning back to step 308, if the resource activity is not an allocation request, it is determined whether the activity relates to a de-allocation of a system resource at step 326. If not, the process ends at step 320. Otherwise, the resource management application 210 assigns a value of ‘2’ to the corresponding index at step 328 and de-allocates the resource at step 330. It is then determined whether there are any additional de-allocations of resources at step 332. If not, the process returns to step 306 whereby the resource management application 210 continues to monitor for activity. Otherwise, the process returns to step 328.

As indicated above, the resource management activities provide resource allocation and de-allocation services to resource consumption elements and are implementable for large numbers of resources without requiring appreciable amounts of computer memory and disk space. The resource management activities maintain one or more arrays with an index value pointing to the lowest number range of the available resources and an index value pointing to the highest number range of the available resources. A third index value may be utilized to point to a de-allocated resource that is currently available for re-allocation. This system enables an entity to store only the array indexes for which an index value has been assigned, thus, reducing the amount of storage space typically required for large numbers of resources.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for managing system resources, comprising:
assigning a first value to the lowest index of a range, the lowest index specifying a first available resource in the range, the first value operable for indicating that all resources appearing further in the range are available;
assigning a second value to the highest index of the range, the highest index specifying a last available resource in the range; and
storing only the lowest index of the range and the highest index in the range, along with corresponding first value and second value, in a storage device.

1. The method of claim 1, wherein in response to receiving a first request for a resource, performing:
removing the first value from the lowest index;
allocating a resource corresponding to the lowest index;
incrementing the lowest index by one; and
assigning the first value to the lowest index incremented by one.

2. The method of claim 2, wherein in response to detecting a discontinuation of utilization of a resource, assigning a second value to an index associated with the resource that is no longer utilized, the second value operable for de-allocating the resource that is no longer being utilized, and is further operable for indicating that only the resource corresponding to the index assigned the second value is available for re-allocation.

3. The method of claim 1, wherein resources include physical ports providing access to at least one of:
Internet resources; and
telephone subscribers.

5. The method of claim 1, wherein the resources include virtual channel identifiers associated with a physical port resident on a digital subscriber line access multiplexor.

6. The method of claim 1, wherein the first or second request for a resource originates from at least one of:
an application;
a server; and
a modem.

7. A computer program product for managing system resources, the computer program product including instructions for performing:
assigning a first value to the lowest index of a range, the lowest index specifying a first available resource in the range, the first value operable for indicating that all resources appearing further in the range are available;
assigning a second value to the highest index of the range, the highest index specifying a last available resource in the range; and
storing only the lowest index of the range and the highest index in the range, along with corresponding first value and second value, in a storage device.

8. The computer program product of claim 7, wherein in response to receiving a first request for a resource, performing:
removing the first value from the lowest index;
allocating a resource corresponding to the lowest index;
incrementing the lowest index by one; and
assigning the first value to the lowest index incremented by one.

9. The computer program product of claim 8, wherein in response to detecting a discontinuation of utilization of a resource, assigning a second value to an index associated with the resource that is no longer utilized, the second value operable for de-allocating the resource that is no longer being utilized, and is further operable for indicating that only the resource corresponding to the index assigned the second value is available for re-allocation.

10. The computer program product of claim 7, wherein resources include physical ports providing access to at least one of:
Internet resources; and
telephone subscribers.

11. The computer program product of claim 7, wherein the resources include virtual channel identifiers associated with a physical port resident on a digital subscriber line access multiplexor.

12. The computer program product of claim 7, wherein the first or second request for a resource originates from at least one of:
an application;
a server; and
a modem.

13. A system for managing system resources, comprising:
a resource management application executing on a processor, the processor in communication with consumable resources, the resource management application performing:
assigning a first value to the lowest index in a range, the lowest index specifying a first available resource in the range, the first value operable for indicating that all resources appearing further in the range are available;
assigning a second value to the highest index of the range, the highest index specifying a last available resource in the range; and
storing only the lowest index of the range and the highest index in the range, along with corresponding first value and second value, in a storage device.

14. The system of claim 13, wherein in response to receiving a first request for a resource, the resource management application performs:
removing the first value from the lowest index;
allocating a resource corresponding to the lowest index;
incrementing the lowest index by one; and
assigning the first value to the lowest index incremented by one.

15. The system of claim 14, wherein in response to detecting a discontinuation of utilization of a resource, the resource management application performs:
assigning a second value to an index associated with the resource that is no longer utilized, the second value operable for de-allocating the resource that is no longer being utilized, and is further operable for indicating that only the resource corresponding to the index assigned the second value is available for re-allocation.

16. The system of claim 13, wherein resources include physical ports providing access to at least one of:
Internet resources; and
telephone subscribers.

17. The system of claim 13, wherein the resources include virtual channel identifiers associated with a physical port resident on a digital subscriber line access multiplexor.

18. The system of claim 13, wherein the first or second request for a resource originates from at least one of:
an application;
a server; and
a modem.
